(19) United States
(12) Patent Application Publication
(10) Pub. No.: US 2025/0285296 A1
(43) Pub. Date: Sep. 11, 2025

(54) NEURAL ORDINARY DIFFERENTIAL EQUATIONS FOR OPTICAL FLOW ESTIMATION

(71) Applicant: QUALCOMM Incorporated, San Diego, CA (US)

(72) Inventors: Leyla MIRVAKHABOVA, Amsterdam (NL); Jisoo JEONG, San Diego, CA (US); Hanno ACKERMANN, Amsterdam (NL); Hong CAI, San Diego, CA (US); Farhad GHAZVINIAN ZANJANI, Almere (NL); Fatih Murat PORIKLI, San Diego, CA (US)

(21) Appl. No.: 18/664,137

(22) Filed: May 14, 2024

Related U.S. Application Data
(60) Provisional application No. 63/562,195, filed on Mar. 6, 2024.

(51) Int. Cl. G06T 7/246

(52) U.S. Cl. CPC G06T 7/248; G06T 2207/20084

(57) ABSTRACT

Techniques are described for optical flow estimation. For example, a computing device can obtain images including at least a first image and a second image. The computing device can process the first image and the second image using a first neural network to obtain a set of features representing the first image and the second image. The computing device can predict, based on the set of features, a latent representation of a change in an optical flow between at least the first image and the second image using a neural ordinary differential equation that uses a second neural network to generate a predicted latent representation. The computing device can estimate the optical flow based on the predicted latent representation to generate an estimated optical flow, wherein the optical flow is associated with movement of pixels from at least the first image to the second image.

### CROSS-REFERENCE TO RELATED APPLICATIONS

This application claims the benefit of Provisional Patent Application No. 63/562,195, filed on Mar. 6, 2024, which is hereby incorporated by reference, in its entirety and for all purposes.

### TECHNICAL FIELD

The present disclosure generally relates to optical flow estimation. For example, aspects of the present disclosure include systems and techniques of using a neural ordinary differential equation (ODE) to represent an optical flow update or a change in optical flow in a flexible manner (e.g., a transformer-based ODE in which the number of steps or iterations used can be varied during training and/or inference).

### BACKGROUND

Machine learning models (e.g., deep neural networks, such as large language models (LLMs), convolutional neural networks, transformers, diffusion models, etc.) are trained to provide an inference or prediction based on input data. For example, deep neural networks (e.g., LLMs, etc.) can be pre-trained on large datasets to generalize to a wide range of tasks. Applications of deep neural networks include optical flow estimation, text summarization, text generation, sentiment analysis, content creation such as performing generative operations, chatbots, virtual assistants, and conversational artificial intelligence, named entity recognition, speech recognition and synthesis, image annotation, text-to-speech synthesis, spell correction, machine translation, recommendation systems, fraud detection, accomplishing tasks and code generation.

### SUMMARY

Systems and techniques are described herein for providing an improved approach to estimating optical flow. Optical flow can be important for many high-level tasks in computer vision, such as video recognition and tracking, and in other technology fields. Various state-of-the-art models utilize neural networks to predict optical flow, many of which require running a recurrent neural network (RNN) for a prescribed number of iterations to predict optical flow. The fixed number of iterations is determined empirically and may not work well for data that has different characteristics from the training set. The systems and techniques described herein provide a new solution to estimate optical flow and can be used to obtain better results (e.g., on several benchmark datasets). The fixed number of steps can lead to suboptimal performance as it is not data-driven. This disclosure proposes to use an implicit layer for the estimation of optical flow. One advantage is that it models an equilibrium process in a variable number of compute steps that are determined by the data. According to some aspects, an apparatus to estimate optical flow is provided. The apparatus includes one or more memories and one or more processors coupled to the one or more memories and configured to: obtain the plurality of images including at least a first image and a second image; process the first image and the second image using a first neural network to obtain a set of features representing the first image and the second image; predict, based on the set of features representing the first image and the second image, a latent representation of a change in an optical flow between at least the first image and the second image using a neural ordinary differential equation that uses a second neural network to generate a predicted latent representation; and estimate the optical flow based on the predicted latent representation to generate an estimated optical flow, wherein the optical flow is associated with movement of pixels from at least the first image to the second image.

In some aspects, a method for estimating optical flow is provided. The method includes: obtaining a plurality of images including at least a first image and a second image; processing the first image and the second image using a first neural network to obtain a set of features representing the first image and the second image; predicting, based on the set of features representing the first image and the second image, a latent representation of a change in an optical flow between at least the first image and the second image using a neural ordinary differential equation that uses a second neural network to generate a predicted latent representation; and estimating the optical flow based on the predicted latent representation to generate an estimated optical flow, wherein the optical flow is associated with movement of pixels from at least the first image to the second image.

In some aspects, an apparatus to estimate optical flow is provided. The apparatus includes: means for obtaining a plurality of images including at least a first image and a second image; means for processing the first image and the second image using a first neural network to obtain a set of features representing the first image and the second image; means for predicting, based on the set of features representing the first image and the second image, a latent representation of a change in an optical flow between at least the first image and the second image using a neural ordinary differential equation that uses a second neural network to generate a predicted latent representation; and means for estimating the optical flow based on the predicted latent representation to generate an estimated optical flow, wherein the optical flow is associated with movement of pixels from at least the first image to the second image.

In some aspects, a non-transitory computer-readable medium is provided having stored thereon instructions which, when executed by one or more processors, cause the one or more processors to: obtain a plurality of images including at least a first image and a second image; process the first image and the second image using a first neural network to obtain a set of features representing the first image and the second image; predict, based on the set of features representing the first image and the second image, a latent representation of a change in an optical flow between at least the first image and the second image using a neural ordinary differential equation that uses a second neural network to generate a predicted latent representation; and estimate the optical flow based on the predicted latent representation to generate an estimated optical flow, wherein the optical flow is associated with movement of pixels from at least the first image to the second image.

In some aspects, one or more of apparatuses described herein include a mobile device (e.g., a mobile telephone or so-called “smart phone” or other mobile device), a wireless communication device, a vehicle or a computing device, system, or component of the vehicle or an autonomous driving vehicle, an extended reality (XR) device (e.g., a virtual reality (VR) device, an augmented reality (AR) device, or a mixed reality (MR) device), a wearable device, a personal computer, a laptop computer, a server computer, a camera, or other device, devices used for image/video editing and image/video generation and editing. In some aspects, the one or more processors include an image signal processor (ISP). In some aspects, each apparatus includes a camera or multiple cameras for capturing one or more images. In some aspects, each apparatus includes an image sensor that captures the image data. In some aspects, each apparatus includes a display for displaying the image, one or more notifications (e.g., associated with processing of the image), and/or other displayable data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1A is a diagram illustrating an architecture for optical flow estimation, in accordance with some aspects of this disclosure;

FIG. 1B is a diagram illustrating another architecture for optical flow estimation, in accordance with some aspects of this disclosure;

FIG. 2 is a diagram illustrating the use of a gated recurrent unit in the context of estimating an optical flow, in accordance with some aspects of this disclosure;

FIG. 3 is a diagram illustrating a proposed architecture for using ordinary differential equations in estimating an optical flow, in accordance with some aspects of this disclosure;

FIG. 4 is a diagram illustrating an optical different equation update, in accordance with some aspects of this disclosure;

FIG. 5 is a diagram illustrating a neural ordinary differential equation update block, in accordance with some aspects of this disclosure;

FIG. 6 is a diagram illustrating a relationship between a gated recurrent unit related to a neural ordinary differential equation, in accordance with some aspects of this disclosure;

FIG. 7 is a diagram illustrating the implicit nature of the use of a neural ordinary differential equation, in accordance with some aspects of this disclosure;

FIG. 8 illustrates an example process for using a transformer-based neural ordinary differential equation, according to some aspects of this disclosure;

FIG. 9 is a block diagram illustrating an example of a deep learning network, in accordance with some aspects of this disclosure; and

FIG. 10 is a diagram illustrating an example system architecture for implementing certain aspects described herein, in accordance with some aspects of this disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Machine learning systems (e.g., deep neural network systems or models, such as large language models (LLMs), convolutional neural networks (CNNs), recurrent neural networks (RNNs), transformers, diffusion models, etc.) can be used to perform a variety of tasks such as, for example and without limitation, optical flow prediction, generative modeling such as text-to-image generation and text-to-video generation, computer code generation, text generation, speech recognition, natural language processing tasks, detection and/or recognition (e.g., scene or object detection and/or recognition, face detection and/or recognition, speech recognition, etc.), depth estimation, pose estimation, image reconstruction, classification, three-dimensional (3D) modeling, dense regression tasks, data compression and/or decompression, and image processing, among other tasks. Moreover, machine learning models can be versatile and can achieve high quality results in a variety of tasks.

Optical flow relates to pixel-level movement between two images. Optical flow can also be defined for images sequences of more than one image. Optical flow is a flow field which provides, for each pixel in the source image, a vector to the position in the target image. The target image does not need to align with any pixel but can point to the space in between pixels; it is continuous whereas contexts requiring a pixel-level correspondence are discrete. For example, optical flow can be computed as a difference between a position of an image feature in the camera at time t and that of the corresponding image feature in the camera at time t+1. Optical flow can be applied to various tasks or applications, such as object tracking, action recognition tasks, video compression, video frame interpolation, vehicle applications, extended reality (XR) applications (e.g., virtual reality (VR), augmented reality (AR) device, or mixed reality (MR) applications), camera-related applications, among others.

Recent years have seen significant progress in optical flow estimation thanks to the development of deep learning. Some optical flow models first operate on the images in lower resolutions due to memory constraints. Intermediate coarse level results may be up-sampled to match the original resolution and then refined using a neural network (e.g., a recurrent neural network (RNN) update block).

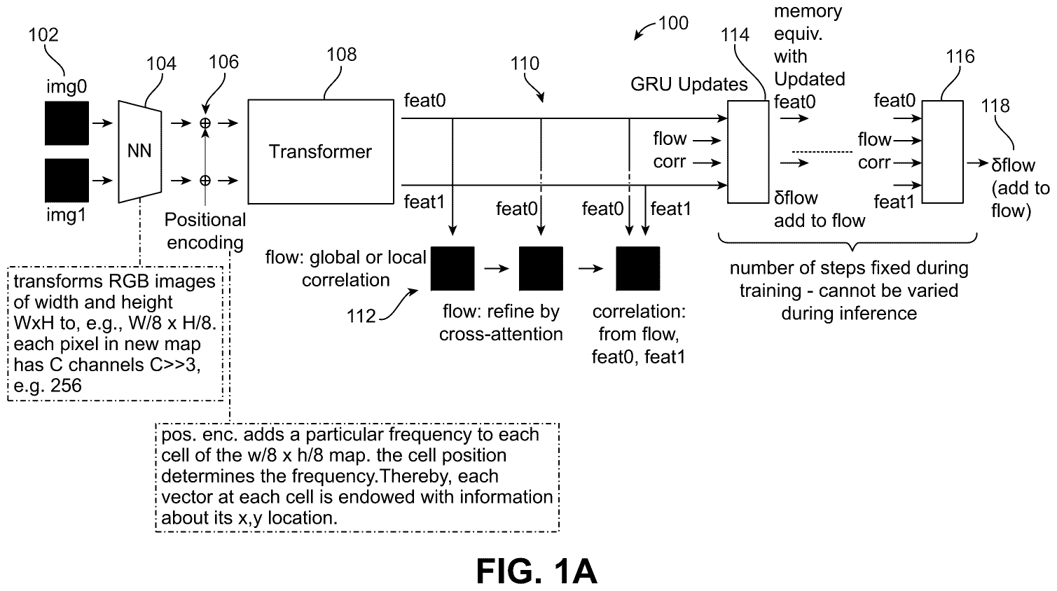

In some cases, a gated recurrent unit (GRU) is used. A GRU includes a gating mechanism in an RNN. The RNN block can imitate iterative optimization steps to solve for optical flow. For example, Recurrent All-Pairs Field Transforms (RAFT) for optical flow provides significant accuracy improvement and strong generalizability as compared to previous models. In RAFT, a GRU is used to perform iterative updates of the flow estimate, which resembles an optimization process. The GRU is also adopted by the latest state-of-the-art optical flow models such as in FlowFormer. FIG. 1B illustrates the RAFT for optical flow with the GRU-based update.

While the GRU enables significant performance improvement, there are several shortcomings. For example, a long update path makes the overall model optimization more difficult. Further, the number of RNN iterations is manually determined during training and becomes fixed (as opposed to abiding by a stopping criterion such as in numerical optimization). For instance, the number of iterations can be empirically chosen based on results on the dataset. The number of steps is fixed during training and cannot be varied during inference of such neural network. Fixing the number of iterations may not be feasible on new, unseen test data where ground-truth labels are not available. For instance, there is no “validation dataset”, based on which one can select the best iteration number. RNNs can be difficult to optimize when the number of iterations is large. In some cases, RNNs are difficult to quantize to integer precision which cause RNNs to be less efficient to run on mobile device.

The GRU-based solution also enforces a discrete setting of the refinement. The discrete aspect of the process limits the preciseness of the learning, especially when the underlying dynamics are complex. In addition, as noted above, from a practical point of view, GRU (or in general, RNN) requires a prescribed number of iterations. In existing optical flow works, the iteration numbers are defined manually or found via grid searches. Moreover, the number can be different between training and testing or inference. There is a lack of any principled way to determine the best number of iterations, especially when running the model on new, unseen data.

Systems and techniques are described herein for providing an improved approach to optical flow estimation. The systems and techniques provide a novel approach that can model the continuous dynamics of the optical flow field learning. Unlike techniques that predominately use a GRU to iteratively compute the flow update, the systems and techniques use a neural network to predict the derivative of the latent features which are then decoded to update the flow estimate. The systems and techniques can allow for more precise learning of the optical flow field and as a result, can lead to higher optical flow estimation accuracy. By leveraging the systems and techniques described herein, a fixed iteration number does not need to be strictly followed. Instead, a stopping criterion can be defined that allows the number of optimization steps to be adaptive, depending on current data being processed.

According to various aspects, the systems and techniques can use a neural ordinary differential equation (ODE) to represent an optical flow estimation, an optical flow update or a change in optical flow in a flexible manner. The ODE can be based on one or more types of neural network models. For instance, in some cases, the ODE is a transformer-based ODE in which the number of steps or iterations used during training and/or inference is dynamic or flexible. In some cases, the ordinary differential equation can be used to represent a change in the optical flow. For instance, the neural ODE can parametrize a derivative (or change in optical flow) of a hidden state of the neural network model (e.g., a transformer neural network model). In some cases, the neural ODE provides an implicit layer for the estimation of optical flow. While examples are described herein using optical flow for illustrative purposes, the principles disclosed herein can apply to other areas as well.

The systems and techniques provide flexibility in the number of iterations or steps used during training and/or inference. For example, the use of the neural ODE is advantageous in that it can model an equilibrium process in a variable number of compute steps (or iterations) that can be determined by the data processed by the model. The use of the neural ODE (e.g., the transformer-based neural ODE) can allow for more precise learning of the underlying dynamics of a differential model. The systems and techniques also allow for a continuous approximation of the learned differential equation, as opposed to the discrete sequence of hidden states as in RNNs.

The systems and techniques can model the continuous dynamics of the optical flow field learning. Unlike existing works that predominately use a GRU to iteratively compute the flow update, the systems and techniques use a neural network to predict a derivative (e.g., via ordinary differential equations) of the latent features which are then decoded to update an optical flow estimate. The systems and techniques allow for more precise learning of the optical flow field and as a result, leads to higher optical flow estimation accuracy.

The systems and techniques described herein provide a benefit of avoiding the need to prescribe a fixed number of iterations or steps. For example, the systems and techniques can define a stopping criterion that allows the number of optimization steps to be adaptive, depending on the current data. As noted above, the systems and techniques can perform optical flow estimation based on ODEs, which can be beneficial for varying image-to-image motion, which may require an adaptive number of refinements (whereas existing models, such as RAFT, etc., use a pre-determined number of iterations/steps, as noted previously). Prior approaches can lead to less accurate estimates. The proposed modelling of the optical flow by ODEs is more accurate than using other implicit layers that are not suitable for that problem.

In some cases, the neural ODE used by the systems and techniques described herein may be based on an implicit layer. Different from other implicit methods, the ODE is modelled, thus the neural ODE parameterizes the derivative of some quantity. Solvers, for instance based on Runge-Kutta methods, can be used to determine the solution of the ODE by evaluating its integral. The right-hand side of the ODE can be parameterized by a neural network. For example, the ODE can use the neural network to parameterize the right-hand side of the ODE. The neural ODE includes advantages of other implicit methods, but can be more accurate when used to model time-varying differential processes.

Various aspects of the present disclosure will be described with respect to the figures.

FIG. 1A illustrates an example of a system 100 for performing optical flow prediction. The system 100 includes a neural network 104 (NN) and a transformer 108, among other components. The neural network 104 can include a convolutional neural network (CNN) or other backbone network that can extract features from images 102. In some cases, the images 102 can include a first image (e.g., image 0) and a second image (e.g., image 1), and in some cases other images or video input. As shown, the images 102 are processed by the neural network 104. In some cases, the images 102 can include red, green, blue (RGB) images. In some aspects, the neural network 104 can transform the images 102 (e.g., RGB images or other images) of width and height W×H to a new value such as W/8× H/8 or to generate a W/8×H/8 map (e.g., a feature map including features representing the images 102). Each value (or pixel) in the new map has C channels (e.g., in some cases, C>>3 such as, for example, 256). Other values may also be used. The output of the CNN backbone or neural network 104 is processed via addition component 106 via positional encoding to add a particular frequency to each cell of the W/8×H/8 map. The cell position determines the frequency. Each vector at each cell is endowed with information about its x, y location.

A transformer 108 receives the positional encoding and uses self attention and cross attention, as is known in transformers, to generate features 110 such as feature 0 and feature 1. Self-attention weighs the importance of different parts of the input images and enable the the model to focus on different regions of the image when making predictions. Cross-attention allows the model to consider relationships between different image sequences. The features can be in a vector structure and can capture various aspects of the input images. The specific features may depend on the architecture and the design of the transformer. The features (feat0, feat1, which are feature representations of the first and second image) are used to refine the flow in a flow path 112 in which there is global or local correlation that occurs. In some aspects, a correlation layer can construct a four-dimensional correlation volume by taking the inner product of all pairs of feature vectors. For example, the flow can be refined by cross-attention and a correlation value can be obtained from the flow, feat0 and feat1. The feat0, feat1, flow and correlation data can be provided to a GRU updates component 114. Details on the flow architecture can be obtained from H. Xu, et al., Gmflow: Learning optical flow via global matching,” in CVPR, 2022, pp 8121-8130, incorporated herein by reference. The GRU updates component 114 provides an optical flow or delta flow which can be described as δflow 118 and a memory which is equivalent with the updated feat0. GMFlow uses feat0 as one of the inputs to the first GRU cell. The second GRU cell then takes the memory lane of the preceding GRU cell as input, etc. The memory output/input of the GRU cell represents feat0 or its updates, respectively. The flow, correlation data, feat0 and feat1 can be provided to a layer 116 for generating the δflow 118. The δflow 118 can be added to the general flow or the current flow as a refinement value. For example, the δflow 118 (or flow update) is generated at a respective iteration and is added to the current flow estimation for refinement of the current flow estimation. The number of steps involved in the GRU updates component 114 and the layer 116 operations is fixed during training and cannot be varied at-inference.

FIG. 1B illustrates a Recurrent All-Pairs Field Transform (RAFT) for optical flow 150. RAFT consists of three main components. First, a feature encoder can include a first feature encoder 152 that extracts per-pixel features from input image 1 and a second feature encoder 154 that extract per-pixel features from an image 2, along with a context encoder 156 that extracts features from only image 1. Second, a correlation layer 158 constructs a 4D W×H×W×H correlation volume by taking the inner product of all pairs of feature vectors. The last 2-dimensions of the 4D volume are pooled at multiple scales to construct a set of multi-scale volumes. Third, a GRU-based update operator 160 recurrently updates an output optical flow 162 by using the current estimate to look up values from the set of correlation volumes. The GRU-based update operator 160 in this case is a discrete GRU-based update. The RAFT for optical flow 150 uses GRU-based updates for optical flow estimation. Current optical flow models all follow this approach, using GRU in a final refinement stage. The modification disclosed herein be applied to any optical flow model containing the refinement step based on GRUs. The modification is to replace the GRU-based update operator 160 with a neural ordinary differential equation.

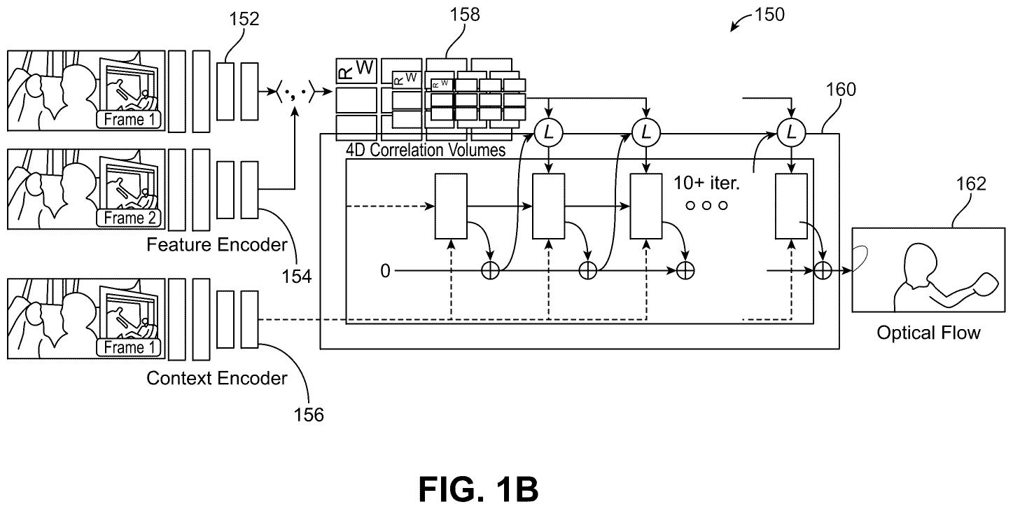

FIG. 2 illustrates in more detail the GRU updates component 114 from FIG. 1A. The diagram 200 illustrates a CNN 202 (which can be a relatively small CNN) which receives the flow and correlation data and concatenates data to generate feat1 and other data which is provided to a concatenation layer 204. The concatenation layer 204 generates data which can be a current estimate of flow, correlation data, and/or feat1. A GRU cell 206 receives two inputs, the data from the concatenation layer 204 and data from memory which can be feat0. The vector feat0 is used in place of the memory input of GRU cell(s). The GRU cell 206 outputs memory used as update of feat0 for a calling module and the δflow 208 which is used to refine a current flow.

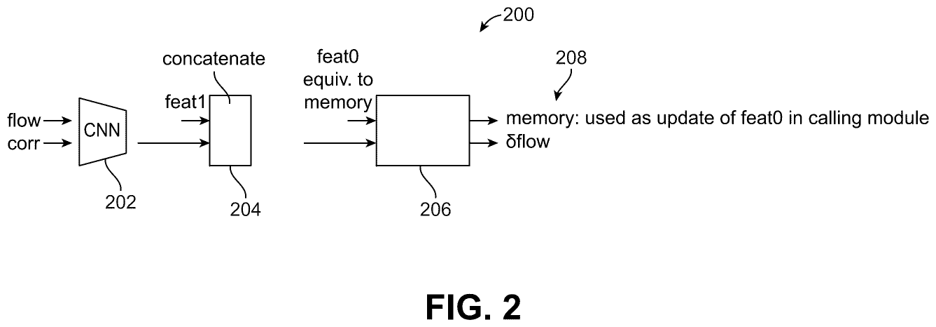

FIG. 3 illustrates an example of a system 300 implementing the proposed architecture in which a neural ODE refinement component 302 (e.g., replacing the GRU updates component 114 and the layer 116 from FIG. 1A) is used to generate a new δflow 304 as a delta flow or flow update. The δflow 304 which is added to the existing flow or to the current flow estimation as a refinement factor. The other components in FIG. 3 are the same as is shown in FIG. 1A. The neural ODE refinement component 302 can also be used to replace the GRU-based update operator 160 of FIG. 1B.

With respect to optical flow estimation, several deep architectures have been proposed for optical flow. Among these, Recurrent All Pairs Field Transforms (RAFT) introduced above has shown significant performance improvement over previous methods. Following the structure of RAFT architecture, complementary studies proposed advancements on feature extraction, 4D correlation volume, recurrent update blocks, and more recently, transformer extensions. In the latest state-of-the-art optical flow models, GRUs are commonly used to refine the optical flow estimation in the last stage of the model architecture.

Models using implicit layers have been proposed for optical flow estimation. The implicit models use a fixed-point iteration to solve an implicit equation. Due to the variable number of iterations, implicit methods can be more accurate than methods which rely on a pre-determined number of refinements.

The use of Neural Ordinary Differential Equations (NODE) can apply to this disclosure. Such a method also relies on an implicit layer. Differently from other implicit methods, an ordinary differential equation (ODE) is modelled, thus they parameterize the derivative of some quantity. Solvers, for instance based on Runge-Kutta methods by way of example, are used to determine the solution of the ODE by evaluating its integral. In some cases, the right-hand side of the ODE can be parameterized by a neural network. NODEs have all the advantages of other implicit methods but can be more accurate when used to model time-varying differential processes.

Optical flow is the displacement field f that maps every position x=(x, y, t) at time t to a position x′=x+f(x) at time t+t by assuming brightness constancy:

$$f ( x ) = f ( x + δ x ) \qquad ( 1 )$$

For small time offset t between the two images, the optic flow constraint amounts to solving a first-order Taylor expansion:

$$\frac{\partial }{\partial t} f = - {J}_{f} ∇ x = g ( f ( x ) , x ) \qquad ( 2 )$$

where J_{f} and V̅x denote the Jacobian and the gradient of the partial derivatives in space.

Some methods predict the solution to Eq. (2) in a single step (GMFlow or global motion flow) while others (e.g., RAFT, GMA (global motion aggregation)-RAFT, GMFlow2, FlowFormer), refine the estimate by a few iterations. However, it is more advantageous to let the data decide how many update steps are necessary. In other words, instead of defining how many times to update the estimate, the disclosed approach is to define some condition that the outputs must satisfy. The approach implies that the system needs to solve Eq. (2). Since the spatial derivatives in Eq. (2) can be straight-forwardly computed, the problem reduces to that of solving an ODE.

One of the main stages in existing optical flow models is the refinement step. Integrating an additional stage into models helps to achieve a higher accuracy. Usually, the refinement was done by iteratively applying GRU-based updates as shown in FIG. 1A. In such a setting, the approach is to enforce a discrete nature of the refinement. Instead, this disclosure proposes in FIG. 3 to generalize the approach to the continuous case by replacing the GRU updates component 114 and layer 116 with the neural ODE refinement component 302. Moreover, GRU-based update may be rewritten in a NODE setting making it more general and which provides the benefits outlined above such as not being locked into a fixed number of iterations.

An additional strength of the disclosed approach is the following. Training datasets for optical flow models have different amount of the displacement, hence during training more challenging samples may require more refinement steps and vice versa. The use of the neural ODE refinement component 302 allows for an adaptive number of updates that may benefit the training. The neural ODE refinement component 302 is naturally endowed with a property: instead of the predefined number of updates, one can define the tolerance parameter that allows the number of optimization steps to vary from sample to sample. The approach emphasizes that there is a possibility to have a fixed number of underlying optimizing iterations by choosing a non-adaptive solver as fixed-step Runge-Kutta (rk4) solver. In some experiments, one can use an adaptive adjoint Dopri5 solver allowing for O(1) memory in a backward call.

Another appealing aspect of utilizing neural ODEs for optical flow tasks lies in its capacity to enable more versatile representations. Existing models as shown in FIGS. 1A and 1B employ GRUs iterations during the refinement stage. GRUs can be equivalently represented as neural ODEs. By deliberately selecting a specific form for the right-hand side within the neural ODE refinement component 302, one can effectively capture the same underlying dynamics as those learned by GRUs. Moreover, the approach allows to extend the solution to accommodate other diverse right-hand sides, thereby representing a broader class of functions.

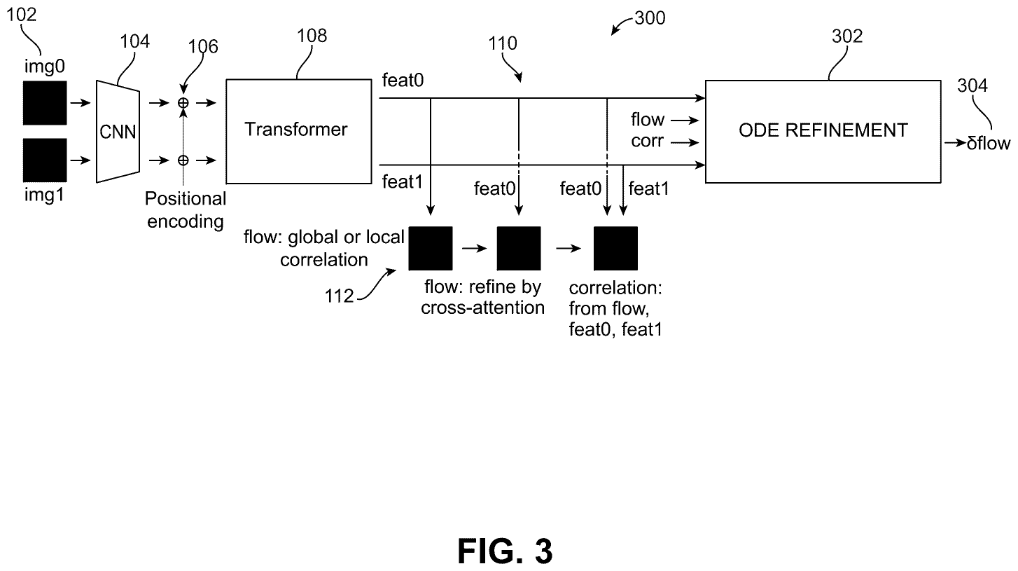

FIG. 4 illustrates an ODE update component 400 that includes a CNN 202 (which can be a relatively small CNN) that receives and concatenates input flow and correlation data and generates output including feat1 to a concatenation layer 204 which can be similar to those shown in FIG. 2. A mixing component 402 can include a small neural network such as a CNN, multilayer perceptron (MLP) or any architecture which can include feat0 which is provided to a concatenation component 404. The output of concatenation component 404 can be provided to a transformer 406 which can represent a right had side of an ODE.

Neural ODEs reformulate recurrent updates in a continuous manner. Neural ODEs reformulate models that have the following recurrent update structure, where h is the hidden state, θ are the parameters and t is a time step hₜ₊₁=hₜ+g (hₜ, θₜ), t ∈{0, . . . , T}, hₜ ∈R^{d}. Suppose one has an update equation given by:

$${h}_{t} = {h}_{t} + g ( {h}_{t} , {θ}_{t} ) , \qquad ( 3 )$$

where t ∈{0, . . . , T} is a time step, hₜ ∈ [symbol] is a hidden state, θ is for model parameters and g(·) is a dynamics generating function. The continuous version of the dynamics generating function can be written as:

$$\frac{d h ( t )}{d t} = g ( h ( t ) , t , {θ}_{t} ) \qquad ( 4 )$$

In practice, the righthand side of the equation (4) (g (h (t), t, θₜ)) is parametrized by a neural network. In the neural ODE, the right-hand-side function of the differential equation is also parameterized using a neural network. The integration is done by a black-box differential equation solver 408 (e.g., Euler, Runge-Kutta, etc.). In experiments, one can use an adjoint sensitivity method requiring only O(1) memory (which uses a constant space or where an algorithm uses a fixed amount of memory that does not depend on input size). The only parameter is the tolerance parameter guiding the convergence of the black-box differential equation solver 408. During NODE training, the output is calculated using black-box differential equation solvers. For example, during neural ODE training, the output is calculated using the black-box differential equation solver 408. Certain types of these solvers enable memory-efficient backpropagation to be achieved for updating the model parameters. In essence, instead of explicitly parametrizing the underlying function itself, the system parametrizes the change of the function.

In FIG. 4, the output of the black-box differential equation solver 408 can include data that is discarded or discarded data 410 as part of the output so that the tensor dimensions fit and the delta flow δflow 412 that is added to the current flow estimation as a refinement value.

Next is discussed the parameterizing of the righthand side of the neural ODE. In optical flow models the flow estimation f is usually iteratively updated as fₖ₊₁=fₖ₊₁+V̅f. In the disclosed method, the approach is to model V̅f as an output of the neural ODE refinement component 302.

One can represent the GRU updates component 114 as a neural ODE as noted above. Neural ODE setting allows one to represent the same learning path as in GRUs. One can get an equivalent update as explained next.

The convolutional GRU update used in RAFT, GMFlow and FlowFormer has the following form:

$${z}_{t} = σ ( C o n {v}_{3 \times 3} [ {h}_{t - 1} , {x}_{t} ] , {W}_{z} ) ) \qquad ( 5 )$$

$${r}_{t} = σ ( C o n {v}_{3 \times 3} [ {h}_{t - 1} , {x}_{t} ] , {W}_{r} ) ) \qquad ( 6 )$$

$${\tilde{h}}_{t} = tanh ( {Conv}_{3 \times 3} [ {r}_{t} ⊙ {h}_{t - 1} , {x}_{t} ] , {W}_{h} ) ) \qquad ( 7 )$$

$${h}_{t} = ( 1 - {z}_{t} ) ⊙ {h}_{t - 1} + {z}_{t} ⊙ {\tilde{h}}_{t} \qquad ( 8 )$$

Within the neural ODE setting, equation (8) can be represented as follows:

$$\frac{d h ( t )}{d t} = ( 1 - z ( t ) ) ⊙ ( \tilde{h} ( t ) - ( h ( t ) ) ) \qquad ( 9 )$$

The transformer right-hand-side is discussed next. Since the approach does not limit itself to the specific type of the architecture for the righthand side of the ODE, an alternative option is to use a transformer-based righthand side. The option allows to model more global dependencies due to an increased receptive field. The right-hand-side can be represented by various families of neural networks including, but not limited to, convolutional/residual networks, transformer-based architectures, and so forth. Convolutional blocks, equivalent continuous version of GRU update blocks and attention blocks can be used as well.

In experiments, the inventors considered a simple transformer block. Since the dynamics modeled by ODE has to have the same output dimension as the input, one can apply an additional module that projects the concatenated flow and correlation. To do so, one can apply either a standard convolutional layer or a depth-wise convolution for a better channel-wise mixing.

Training loss is needed for training a model. One can adopt the same training losses as in baseline models as shown in equation (10):

$$ℒ = {\sum }_{i = 1}^{N} {γ}^{N - 1} {‖ {f}_{gt} - {f}_{i} ‖}_{1 ,} \qquad ( 10 )$$

where f_{gt} is a ground truth flow, fᵢ is a predicted flow on the i-th timestamp and γ=0.8 is a weighting coefficient.

For the architectural details, the neural ODE righthand side block can use a transformer block with input and output hidden dimension d=128. Other values for “d” are also contemplated as well. The hidden dimension in a multilayer perceptron (MLP) layer can equal d=128 or other values. For the mixing network mapping:

$$NN ( [ flow , corr ] ) : {ℝ}^{{d}_{i n p}} \times {ℝ}^{{d}_{h i d}} \to {ℝ}^{{d}_{h i d}} ,$$

In some aspects, at least two versions may be used, such as simple convolution or a depth wise convolution from dᵢₙₚ+d_{hid} to d_{hid} (e.g., with kernel size of 3 and padding of 1). In some cases, lowering the learning rate can help the convergence.

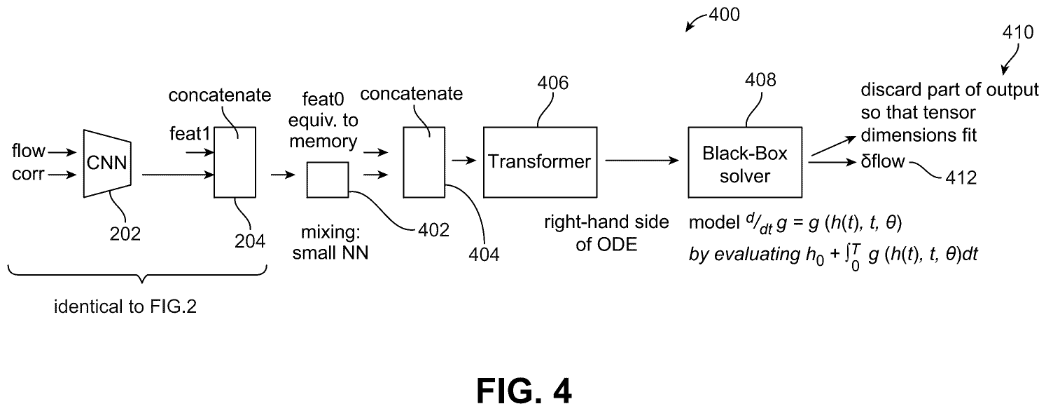

FIG. 5 illustrates a transformer-based right-hand-side neural ODE update block 500 that includes a correlation tensor 502 and context data 504 provided to a transformer used as right-hand-side transformer block 506 that includes a multi-head attention block 508, an additive and normalization block 510, a feed forward block 512 and another additive and normalization block 514. The transformer can be used as the right-hand side in Eq. (4).

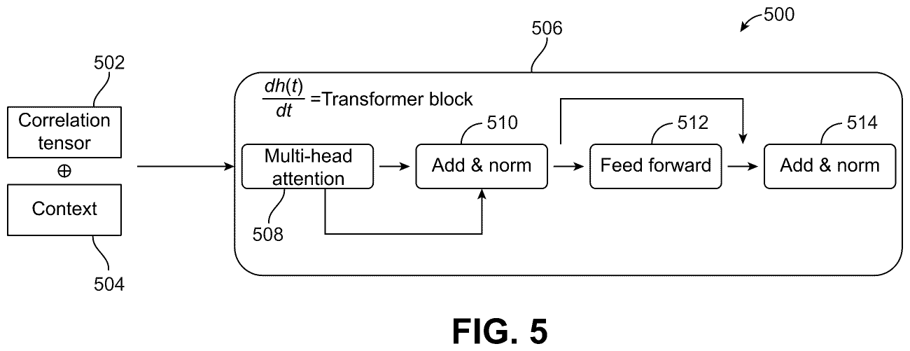

The differences between the GRU model and the use of the neural ODE include that the GRU approach is explicit in which y=f(x) and there are a fixed number of iterations as mentioned above. FIG. 6 illustrates a graphical representation of the two approaches 600 that includes how the GRU model 602 is a subset of the neural ODE model 604 meaning that there are more options available and more flexibility available in the neural ODE model. The GRU model can be obtained from the neural ODE by choosing a particular, parameter-free form of the right-hand side. The GRU model is also discrete as discussed above.

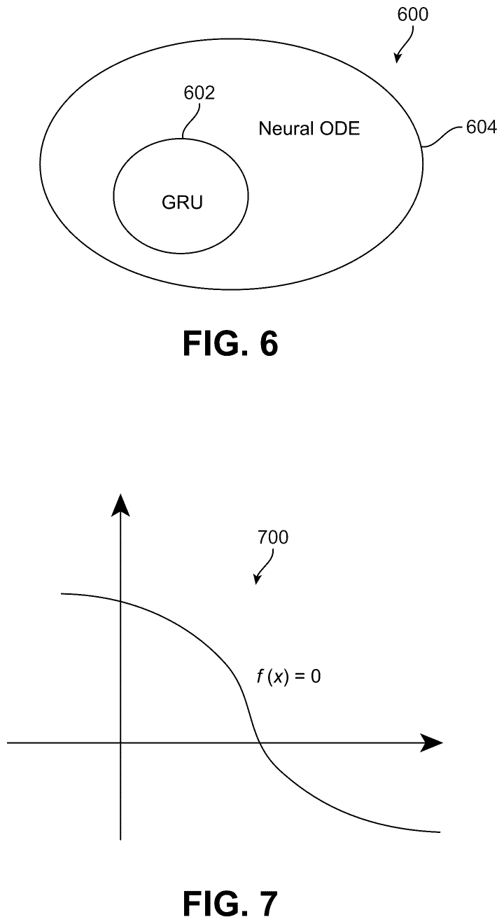

The neural ODE model is implicit in which the approach is to solve f(x)=0 or as shown in FIG. 7, the graph 700 illustrates solving the equation f(x) for where it crosses the x axis. There are an adaptive number of iterations are possible and the number depends on the tolerance. The right-hand-side approach is parametrized by a neural network, e.g.: a convolutional block; an equivalent GRU update; a transformer block. The right-hand-side approach can have higher expressive power and can be continuous.

With the neural ODE model, the model parametrizes the change of the hidden states. Equivalently, the system approximates the underlying function with a second-order degree expansion that makes the optimization more precise. In optical flow estimation, in each iteration, a delta flow (i.e., flow update) is produced, which is added to the current flow estimation to refine it. As the hidden state is used to decode the delta flow, the neural ODE model learns a first derivative of the optical flow which itself is a first derivative. As optical flow in general models the displacement of pixels across frames, in the disclosed approach, the system learns the acceleration of the pixel movement or the change of the optical flow. The approach is a more powerful learning model that can make optical flow estimation more precise.

The neural ODE-based approach is the first to be used for optical flow estimation. The approach provides a more powerful learning model that learns the acceleration of the pixel movement, as compared to velocity (as in existing models that use RNNs to learn the flow changes). The solution therefore offers more precise learning and more accurate flow estimation. The proposed transformer-based neural ODE architecture is effective for the practical vision task of optical flow estimation. The disclosed approach is general, which can be utilized for any optical flow estimation models that require iterative updates/refinement.

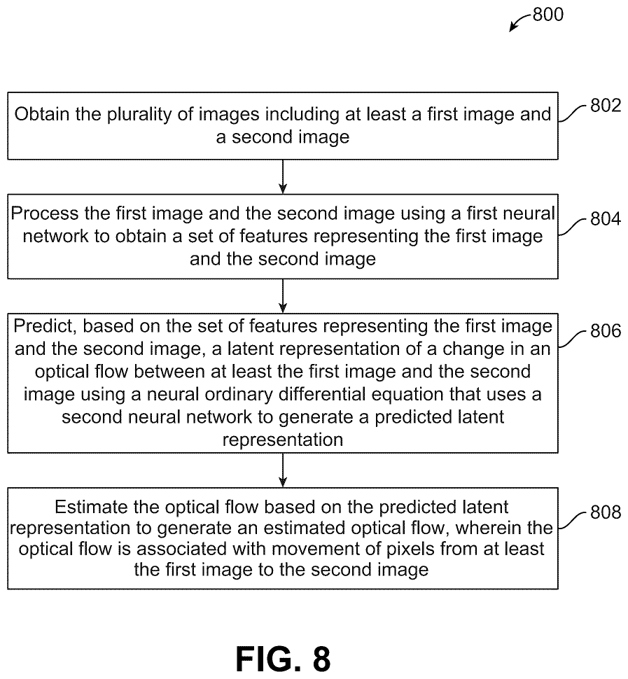

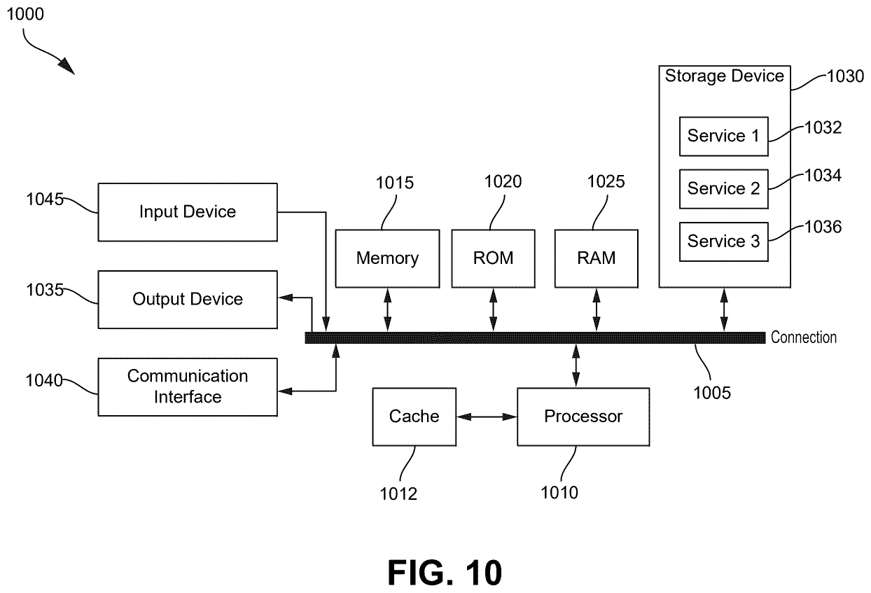

FIG. 8 is a flowchart illustrating an example process 800 for providing optical flow estimation. The process 800 can be performed by a computing device or system (e.g., a computing device implementing the system 300 of FIG. 3, the ODE update component 400 of FIG. 4, the transformer-based right-hand-side neural ODE update block 500 of FIG. 5, etc.) or by a component or system (e.g., a chipset, one or more processors such as one or more central processing units (CPUs), digital signal processors (DSPs), graphics processing units (GPUs), neural signal processors (NSPs), neural processing units (NPUs), any combination thereof, and/or other type of processor(s), or other component or system) of the computing device. The operations of the process 800 may be implemented as software components that are executed and run on one or more processors (e.g., processor 1010 of FIG. 10 or other processor(s)). Further, the transmission and reception of signals by the computing device in the process 800 may be enabled, for example, by one or more antennas and/or one or more transceivers (e.g., wireless transceiver(s)).

At block 802, the computing device (or component thereof) can obtain the plurality of images including at least a first image and a second image.

At block 804, the computing device (or component thereof) can process the first image and the second image using a first neural network to obtain a set of features representing the first image and the second image. In some aspects, the first neural network includes a feature encoder and a context encoder (e.g., a shown in FIG. 1B, which can be implemented in or with the system 300 of FIG. 3, the ODE update component 400 of FIG. 4, the transformer-based right-hand-side neural ODE update block 500 of FIG. 5, etc.). In one illustrative example, the first neural network includes a convolutional neural network (as an example of a feature encoder). In some cases, the set of features includes a four-dimensional volume based on output from the feature encoder and context encoder data output from the context encoder.

At block 806, the computing device (or component thereof) can predict, based on the set of features representing the first image and the second image, a latent representation of a change in an optical flow between at least the first image and the second image using a neural ordinary differential equation that uses a second neural network (e.g., a right-hand side of the ODE is parameterized by the second neural network) to generate a predicted latent representation. The latent representation of the change in the optical flow may be between multiple images (e.g., K-1 images) and the second image (e.g., an image K), wherein the multiple images comprise the first image and at least one other image.

In some aspects, the computing device (or component thereof) can update parameters of the first neural network and the second neural network based on a loss function to generate updated parameters. In some cases, the loss function can be based on a difference between the estimated optical flow and a ground truth optical flow. In one illustrative example, the loss can be represented as follows:

$$ℒ = {\sum }_{i = 1}^{N} {γ}^{N - i} {‖ {f}_{gt} - {f}_{i} ‖}_{1}$$

where Fᵢ is the estimated optical flow and f_{gt} is the ground truth optical flow.

The computing device (or component thereof) can obtain a third image and can process the second image and the third image using the first neural network with the updated parameters to obtain a set of features representing the second image and the third image. The computing device (or component thereof) can predict, based on the set of features representing the second image and the third image, an updated latent representation of an optical flow between the second image and the third image using the neural ODE that uses the second neural network with the updated parameters (e.g., to parameterize the right-hand side of the ODE). In some aspects, the second neural network includes a multilayer perceptron, a transformer (e.g., the transformer 406 of FIG. 4, the transformer block of FIG. 5, etc.), a convolutional neural network, any combination thereof, and/or other neural network.

At block 808, the computing device (or component thereof) can estimate the optical flow based on the predicted latent representation to generate an estimated optical flow, wherein the optical flow is associated with movement of pixels from at least the first image to the second image. The optical flow includes an estimate of per pixel movement from the first image to the second image. In some aspects, to estimate the optical flow based on the predicted latent representation, the computing device (or component thereof) can decode the predicted latent representation.

In some aspects, an apparatus (e.g., the transformer 406, a black-box differential equation solver 408, the computing system 1000, the neural ODE refinement component 302 or any subset therefore of a combination thereof) to estimate an optical flow can include one or more memories (e.g., memory 1015, ROM 1020, RAM 1025, cache 1012 or combination thereof); and one or more processor (e.g., processor 1010) coupled to the one or more memories and configured to: obtain a first K-1 images and a second K image; process the first K-1 images and the second K image using a first neural network to obtain a set of features representing the first K-1 images and the second K image; predict, based on the set of features representing the first K-1 images and the second K image, a latent representation of a change between an optical flow between the first K-1 images and the second K image using a neural ordinary differential equation (ODE) that uses a second neural network (e.g., a right-hand side of the ODE is parameterized by the second neural network) to generate a predicted latent representation; and estimate the optical flow based on the predicted latent representation to generate an estimated optical flow, wherein the optical flow is associated with movement of pixels from the first K-1 images to the second K image.

In some aspects, an apparatus (e.g., the transformer 406, a black-box differential equation solver 408, the computing system 1000, the neural ODE refinement component 302 or any subset therefore of a combination thereof) is disclosed to estimate an optical flow, the apparatus can include one or more: means for obtaining a first K-1 images and a second K image; means for processing the first K-1 images and the second K image using a first neural network to obtain a set of features representing the first K-1 images and the second K image; means for predicting, based on the set of features representing the first K-1 images and the second K image, a latent representation of a change between an optical flow between the first K-1 images and the second K image using a neural ODE that uses a second neural network (e.g., a right-hand side of the ODE is parameterized by the second neural network) to generate a predicted latent representation; and means for estimating the optical flow based on the predicted latent representation to generate an estimated optical flow, wherein the optical flow is associated with movement of pixels from the first K-1 images to the second K image.

In some aspects, a computer-readable device (e.g., memory 1015, ROM 1020, RAM 1025, cache 1012 or combination thereof) stores instructions which, when executed by one or more processors, cause the one or more processors to be configured to: obtain a first K-1 images and a second K image; process the first K-1 images and the second K image using a first neural network to obtain a set of features representing the first K-1 images and the second K image; predict, based on the set of features representing the first K-1 images and the second K image, a latent representation of a change between an optical flow between the first K-1 images and the second K image using a neural ODE that uses a second neural network (e.g., a right-hand side of the ODE is parameterized by the second neural network) to generate a predicted latent representation; and estimate the optical flow based on the predicted latent representation to generate an estimated optical flow, wherein the optical flow is associated with movement of pixels from the first K-1 images to the second K image.

In some aspects, a non-transitory computer-readable medium having stored thereon instructions which, when executed by one or more processors, cause the one or more processors to perform operations according to any of operations in block 802 through block 808. In another example, an apparatus can include one or more means for performing operations according to any of operations shown in block 802 through block 808.

In some cases, the computing device of process 800 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 800 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 800 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation. Any number of the described operations can be combined in any order and/or in parallel to implement the processes.

Additionally, process 800 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

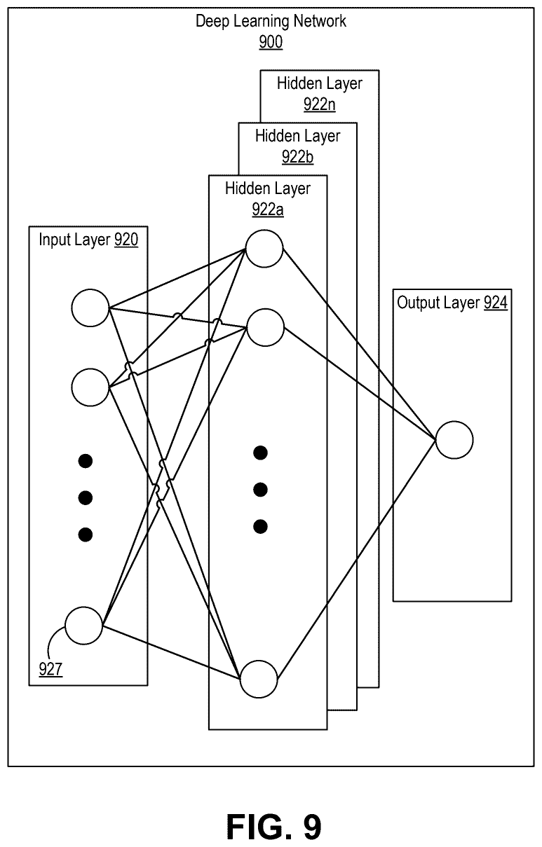

As described above, one or more of the machine learning systems or models described herein may be implemented using a neural network or multiple neural networks. FIG. 9 is an illustrative example of a deep learning neural network or neural network 900 that can be used by the neural network 900 of FIG. 9. An input layer 920 includes input data. In one illustrative example, the input layer 920 can include data representing the pixels of an input video frame. The neural network 900 includes multiple hidden layers 922a, 922b, through 922n. The hidden layers 922a, 922b, through 922n include “n” number of hidden layers, where “n” is an integer greater than or equal to one. The number of hidden layers can be made to include as many layers as needed for the given application. The neural network 900 further includes an output layer 924 that provides an output resulting from the processing performed by the hidden layers 922a, 922b, through 922n. In one illustrative example, the output layer 924 can provide a classification for an object in an input video frame. The classification can include a class identifying the type of object (e.g., a person, a dog, a cat, or other object).

The neural network 900 is a multi-layer neural network of interconnected nodes. Each node can represent a piece of information. Information associated with the nodes is shared among the different layers and each layer retains information as information is processed. In some cases, the neural network 900 can include a feed-forward network, in which case there are no feedback connections where outputs of the network are fed back into itself. In some cases, the neural network 900 can include a recurrent neural network, which can have loops that allow information to be carried across nodes while reading in input.

Information can be exchanged between nodes through node-to-node interconnections between the various layers. Nodes of the input layer 920 can activate a set of nodes in the first hidden layer 922a. For example, as shown, each of the input nodes of the input layer 920 is connected to each of the nodes of the first hidden layer 922a. The nodes of the hidden layers 922a, 922b, through 922n can transform the information of each input node by applying activation functions to the information. The information derived from the transformation can then be passed to and can activate the nodes of the next hidden layer 922b, which can perform their own designated functions. Example functions include convolutional, up-sampling, data transformation, and/or any other suitable functions. The output of the hidden layer 922b can then activate nodes of the next hidden layer, and so on. The output of the last hidden layer 922n can activate one or more nodes of the output layer 924, at which an output is provided. In some cases, while nodes (e.g., node 927) in the neural network 900 are shown as having multiple output lines, a node has a single output and all lines shown as being output from a node represent the same output value.

In some cases, each node or interconnection between nodes can have a weight that is a set of parameters derived from the training of the neural network 900. Once the neural network 900 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 900 to be adaptive to inputs and able to learn as more and more data is processed.

The neural network 900 is pre-trained to process the features from the data in the input layer 920 using the different hidden layers 922a, 922b, through 922n in order to provide the output through the output layer 924. In an example in which the neural network 900 is used to identify objects in images, the neural network 900 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 900 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 900 is trained well enough so that the weights of the layers are accurately tuned.

For the example of identifying objects in images, the forward pass can include passing a training image through the neural network 900. The weights are initially randomized before the neural network 900 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 900, the output will likely include values that do not give preference to any particular output value due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 900 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 900 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and n denotes a learning rate. The learning rate can be set to any suitable value, with a high learning rate including larger weight updates and a lower value indicating smaller weight updates.

In some cases, the neural network 900 can be trained using self-supervised learning.

The neural network 900 can include any suitable deep network. One example includes a convolutional neural network (CNN), which includes an input layer and an output layer, with multiple hidden layers between the input and out layers. An example of a CNN is described below with respect to FIG. 10. The hidden layers of a CNN include a series of convolutional, nonlinear, pooling (for downsampling), and fully connected layers. The neural network 900 can include any other deep network other than a CNN, such as an autoencoder, a deep belief nets (DBNs), a Recurrent Neural Networks (RNNs), among others.

The proposed solution is on improving optical flow estimation, which is an important and standard task used in many practical use cases, such as automobile uses, XR, drone use, and camera uses. The proposed model can be used for video processing, temporal information aggregation, tracking, etc. One alternative to the solution disclosed above is to use the RNN/GRU-based updates in optical flow networks. Such an approach might not be as efficient compared to the proposed solution, in terms of both modeling and accuracy.

In some aspects, training of one or more of the machine learning systems or neural networks described herein (e.g., such as the neural network 900 of FIG. 9, the transformer 406 of FIG. 4, the black-box differential equation solver 408 of FIG. 4, among various other machine learning networks described herein) can be performed using online training (e.g., in some case on-device training), offline training, and/or various combinations of online and offline training. In some cases, online may refer to time periods during which the input data (e.g., such as the input data of FIG. 3, etc.) is processed, for instance for performance of a optical flow estimation implemented by the systems and techniques described herein. In some examples, offline training may refer to idle time periods or time periods during which input data is not being processed. Additionally, offline training may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model. A variant of fine-tuning that is very popular in context of large language models is so-called low-rank adaption (LoRA). There, only a small set of additional parameters is trained during the fine-tuning stage, all the original parameters remain unchanged.

FIG. 10 is a diagram illustrating an example of a system for implementing certain aspects of the present disclosure. In particular, FIG. 10 illustrates an example of computing system 1000, which can be for example any computing device making up a computing system, a camera system, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some examples, computing system 1000 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example computing system 1000 includes at least one processing unit (CPU or processor 1010) and connection 1005 that couples various system components including system memory or memory 1015, such as read-only memory (ROM 1020) and random access memory (RAM 1025) to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000. Computing system 1000 can include communications interface 1040, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some examples, a hardware service that performs a particular function can include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “one or more processors configured to,” “one or more processors being configured to,” “one or more processors configured to,” “one or more processors being configured to,” or the like indicates that one processor or multiple processors (in any combination) can perform the associated operation(s). For example, claim language reciting “one or more processors configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “one or more processors configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include one or more memories, one or more processors, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate the interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, then the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:
Aspect 1. An apparatus to estimate an optical flow, the apparatus comprising: one or more memories configured to store a plurality of images; and one or more processors coupled to the one or more memories and configured to: obtain the plurality of images including at least a first image and a second image; process the first image and the second image using a first neural network to obtain a set of features representing the first image and the second image; predict, based on the set of features representing the first image and the second image, a latent representation of a change in an optical flow between at least the first image and the second image using a neural ordinary differential equation that uses a second neural network to generate a predicted latent representation; and estimate the optical flow based on the predicted latent representation to generate an estimated optical flow, wherein the optical flow is associated with movement of pixels from at least the first image to the second image.
Aspect 2. The apparatus of Aspect 1, wherein the one or more processors are configured to: update parameters of the first neural network and the second neural network based on a loss function to generate updated parameters, wherein the loss function is based on a difference between the estimated optical flow and a ground truth optical flow; obtain a third image; process the second image and the third image using the first neural network with the updated parameters to obtain a set of features representing the second image and the third image; and predict, based on the set of features representing the second image and the third image, an updated latent representation of an optical flow between the second image and the third image using a neural ordinary different equation parameterized by the second neural network with the updated parameters.
Aspect 3. The apparatus of Aspect 2, wherein the loss function is based on a difference between the estimated optical flow and the ground truth optical flow.
Aspect 4. The apparatus of any of Aspects 1 to 3, wherein the first neural network comprises a feature encoder and a context encoder.
Aspect 5. The apparatus of any of Aspects 1 to 4, wherein the first neural network comprises a convolutional neural network.
Aspect 6. The apparatus of any of Aspects 1 to 5, wherein the set of features comprises a four-dimensional volume based on output from a feature encoder and context encoder data output from a context encoder.
Aspect 7. The apparatus of any of Aspects 1 to 6, wherein the second neural network comprises at least one of a multilayer perceptron, a transformer, or a convolutional neural network.
Aspect 8. The apparatus of any of Aspects 1 to 7, wherein, to estimate the optical flow based on the predicted latent representation, the one or more processors are configured to decode the predicted latent representation.
Aspect 9. The apparatus of any of Aspects 1 to 8, wherein the optical flow is an estimate of per pixel movement from the first image to the second image.
Aspect 10. The apparatus of any of Aspects 1 to 9, wherein the latent representation of the change in the optical flow is between multiple images and the second image, wherein the multiple images comprise the first image and at least one other image.
Aspect 11. A method for estimating an optical flow, the method comprising: obtaining a plurality of images including at least a first image and a second image; processing the first image and the second image using a first neural network to obtain a set of features representing the first image and the second image; predicting, based on the set of features representing the first image and the second image, a latent representation of a change in an optical flow between at least the first image and the second image using a neural ordinary differential equation that uses a second neural network to generate a predicted latent representation; and estimating the optical flow based on the predicted latent representation to generate an estimated optical flow, wherein the optical flow is associated with movement of pixels from at least the first image to the second image.
Aspect 12. The method of Aspect 11, further comprising: updating parameters of the first neural network and the second neural network based on a loss function to generate updated parameters, wherein the loss function is based on a difference between the estimated optical flow and a ground truth optical flow; obtaining a third image; processing the second image and the third image using the first neural network with the updated parameters to obtain a set of features representing the second image and the third image; and predicting, based on the set of features representing the second image and the third image, an updated latent representation of an optical flow between the second image and the third image using a neural ordinary different equation parameterized by the second neural network with the updated parameters.
Aspect 13. The method of Aspect 12, wherein the loss function is based on a difference between the estimated optical flow and the ground truth optical flow.
Aspect 14. The method of any of Aspects 11 to 13, wherein the first neural network comprises a feature encoder and a context encoder.
Aspect 15. The method of any of Aspects 11 to 14, wherein the first neural network comprises a convolutional neural network.
Aspect 16. The method of any of Aspects 11 to 15, wherein the set of features comprises a four-dimensional volume based on output from a feature encoder and context encoder data output from a context encoder.
Aspect 17. The method of any of Aspects 11 to 16, wherein the second neural network comprises at least one of a multilayer perceptron, a transformer, or a convolutional neural network.
Aspect 18. The method of any of Aspects 11 to 17, wherein, estimating the optical flow based on the predicted latent representation further comprises decoding the predicted latent representation.
Aspect 19. The method of any of Aspects 11 to 18, wherein the optical flow is an estimate of per pixel movement from the first image to the second image.
Aspect 20. The method of any of Aspects 11 to 19, wherein the latent representation of the change in the optical flow is between multiple images and the second image, wherein the multiple images comprise the first image and at least one other image.
Aspect 21. An apparatus to estimate an optical flow, the apparatus comprising: means for obtaining a plurality of images including at least a first image and a second image; means for processing the first image and the second image using a first neural network to obtain a set of features representing the first image and the second image; means for predicting, based on the set of features representing the first image and the second image, a latent representation of a change in an optical flow between at least the first image and the second image using a neural ordinary differential equation that uses a second neural network to generate a predicted latent representation; and means for estimating the optical flow based on the predicted latent representation to generate an estimated optical flow, wherein the optical flow is associated with movement of pixels from at least the first image to the second image.
Aspect 22. The apparatus of Aspect 21, wherein the apparatus is configured to or includes one or more means for performing operations according to any of Aspects 12 to 20.
Aspect 23. A non-transitory computer-readable medium having stored thereon instructions which, when executed by one or more processors, cause the one or more processors to be configured to: obtain a plurality of images including at least a first image and a second image; process the first image and the second image using a first neural network to obtain a set of features representing the first image and the second image; predict, based on the set of features representing the first image and the second image, a latent representation of a change in an optical flow between at least the first image and the second image using a neural ordinary differential equation that uses a second neural network to generate a predicted latent representation; and estimate the optical flow based on the predicted latent representation to generate an estimated optical flow, wherein the optical flow is associated with movement of pixels from at least the first image to the second image.
Aspect 24. The non-transitory computer-readable medium of Aspect 23, wherein the instructions, when executed by the one or more processors, cause the one or more processors to perform operations according to any of Aspects 12 to 20.

What is claimed is:

1. An apparatus to estimate an optical flow, the apparatus comprising:
one or more memories configured to store a plurality of images; and
one or more processors coupled to the one or more memories and configured to:
obtain the plurality of images including at least a first image and a second image;
process the first image and the second image using a first neural network to obtain a set of features representing the first image and the second image;
predict, based on the set of features representing the first image and the second image, a latent representation of a change in an optical flow between at least the first image and the second image using a neural ordinary differential equation that uses a second neural network to generate a predicted latent representation; and
estimate the optical flow based on the predicted latent representation to generate an estimated optical flow, wherein the optical flow is associated with movement of pixels from at least the first image to the second image.

2. The apparatus of claim 1, wherein the one or more processors are configured to:
update parameters of the first neural network and the second neural network based on a loss function to generate updated parameters, wherein the loss function is based on a difference between the estimated optical flow and a ground truth optical flow;
obtain a third image;
process the second image and the third image using the first neural network with the updated parameters to obtain a set of features representing the second image and the third image; and
predict, based on the set of features representing the second image and the third image, an updated latent representation of an optical flow between the second image and the third image using a neural ordinary different equation parameterized by the second neural network with the updated parameters.

3. The apparatus of claim 2, wherein the loss function is based on a difference between the estimated optical flow and the ground truth optical flow.

4. The apparatus of claim 1, wherein the first neural network comprises a feature encoder and a context encoder.

5. The apparatus of claim 1, wherein the first neural network comprises a convolutional neural network.

6. The apparatus of claim 1, wherein the set of features comprises a four-dimensional volume based on output from a feature encoder and context encoder data output from a context encoder.

7. The apparatus of claim 1, wherein the second neural network comprises at least one of a multilayer perceptron, a transformer, or a convolutional neural network.

8. The apparatus of claim 1, wherein, to estimate the optical flow based on the predicted latent representation, the one or more processors are configured to decode the predicted latent representation.

9. The apparatus of claim 1, wherein the optical flow is an estimate of per pixel movement from the first image to the second image.

10. The apparatus of claim 1, wherein the latent representation of the change in the optical flow is between multiple images and the second image, wherein the multiple images comprise the first image and at least one other image.

11. A method for estimating an optical flow, the method comprising:
obtaining a plurality of images including at least a first image and a second image;
processing the first image and the second image using a first neural network to obtain a set of features representing the first image and the second image;
predicting, based on the set of features representing the first image and the second image, a latent representation of a change in an optical flow between at least the first image and the second image using a neural ordinary differential equation that uses a second neural network to generate a predicted latent representation; and
estimating the optical flow based on the predicted latent representation to generate an estimated optical flow, wherein the optical flow is associated with movement of pixels from at least the first image to the second image.

12. The method of claim 11, further comprising:
updating parameters of the first neural network and the second neural network based on a loss function to generate updated parameters, wherein the loss function is based on a difference between the estimated optical flow and a ground truth optical flow;
obtaining a third image;
processing the second image and the third image using the first neural network with the updated parameters to obtain a set of features representing the second image and the third image; and
predicting, based on the set of features representing the second image and the third image, an updated latent representation of an optical flow between the second image and the third image using a neural ordinary different equation parameterized by the second neural network with the updated parameters.

13. The method of claim 12, wherein the loss function is based on a difference between the estimated optical flow and the ground truth optical flow.

14. The method of claim 11, wherein the first neural network comprises a feature encoder and a context encoder.

15. The method of claim 11, wherein the first neural network comprises a convolutional neural network.

16. The method of claim 11, wherein the set of features comprises a four-dimensional volume based on output from a feature encoder and context encoder data output from a context encoder.

17. The method of claim 11, wherein the second neural network comprises at least one of a multilayer perceptron, a transformer, or a convolutional neural network.

18. The method of claim 11, wherein, estimating the optical flow based on the predicted latent representation further comprises decoding the predicted latent representation.

19. The method of claim 11, wherein the optical flow is an estimate of per pixel movement from the first image to the second image.

20. A non-transitory computer-readable medium having stored thereon instructions which, when executed by one or more processors, cause the one or more processors to be configured to:
obtain a plurality of images including at least a first image and a second image;
process the first image and the second image using a first neural network to obtain a set of features representing the first image and the second image;
predict, based on the set of features representing the first image and the second image, a latent representation of a change in an optical flow between at least the first image and the second image using a neural ordinary differential equation that uses a second neural network to generate a predicted latent representation; and
estimate the optical flow based on the predicted latent representation to generate an estimated optical flow, wherein the optical flow is associated with movement of pixels from at least the first image to the second image.
